(19) United States
(12) Patent Application Publication
(10) Pub. No.: US 2011/0117956 A1
(43) Pub. Date: May 19, 2011

(54) INDUSTRIAL RADIO DEVICE WITH UNIFIED PROGRAMMING INTERFACE AND METHODS

(76) Inventors: Yosi Levi, Richmond (CA); Kevin Towers, Fort Langley (CA)

(21) Appl. No.: 12/619,723

(22) Filed: Nov. 17, 2009

(51) Int. Cl. H04M 1/00

(52) U.S. Cl. 455/552.1

(57) ABSTRACT

A radio device includes a radio programming interface eliminating specific dependency between a host application module and a radio module for operation of the radio in a specified communication protocol. Methods of operating the radio device are also disclosed wherein requests and responses communicated between the host application module and radio module are validated and parsed into valid data packets for effective communication, even when the host application and the radio module were not specifically designed for one another.

### BACKGROUND OF THE INVENTION

The field of the invention relates generally to industrial radio devices, and more specifically to software configurable radio devices with a common application interface.

Industrial radio devices are in widespread use for monitoring and control purposes in industrial processes of all types. Data and information may be collected with sensors at multiple points in an industrial process, and the radio devices communicate the collected data information wirelessly to remote locations using, for example, digital radio frequency signal techniques. A good deal of customization exists in known industrial radio devices. That is, radio devices tend to be designed for specific end use applications from both hardware and software perspectives.

### BRIEF DESCRIPTION OF THE DRAWINGS

FIG. 1 schematically illustrates an architecture of an exemplary radio device.

FIG. 2 illustrates the architecture of FIG. 1 with an exemplary Radio Programming Interface (RPI).

FIG. 3 illustrates integration of the RPI in the architecture shown in FIGS. 1 and 2 in the form of a software stack having split function.

FIG. 4 is another integration view of the split function RPI software stack.

FIG. 5 functionally illustrates an exemplary RPI software stack.

FIG. 6 illustrates exemplary request/response paths and processes for an exemplary RPI software stack.

FIG. 7 illustrates exemplary RPI request and response code paths for the RPI software stack.

FIG. 8 illustrates an exemplary local radio module configuration request validation failure state machine and process for the RPI stack.

FIG. 9 illustrates an exemplary local radio module configuration success state machine and process for the RPI stack.

FIG. 10 illustrates an exemplary remote radio module configuration state machine and process for the RPI stack.

FIG. 11 illustrates an exemplary data sending state machine and process for the RPI stack.

FIG. 12 illustrates an exemplary parser engine state machine and process for the RPI stack.

FIG. 13 illustrates an exemplary radio module image download state machine and process.

FIG. 14 illustrates an other exemplary radio module image download state machine and process.

### DETAILED DESCRIPTION OF THE INVENTION

Exemplary embodiments of radio devices, systems, and methods are described hereinbelow that overcome problems and disadvantages in the art. In order to understand the inventive concepts to their fullest extent, some discussion of the particular problems and disadvantages in the art will first be explored, with exemplary embodiments of radio devices, systems and method overcoming those problems and disadvantages to follow.

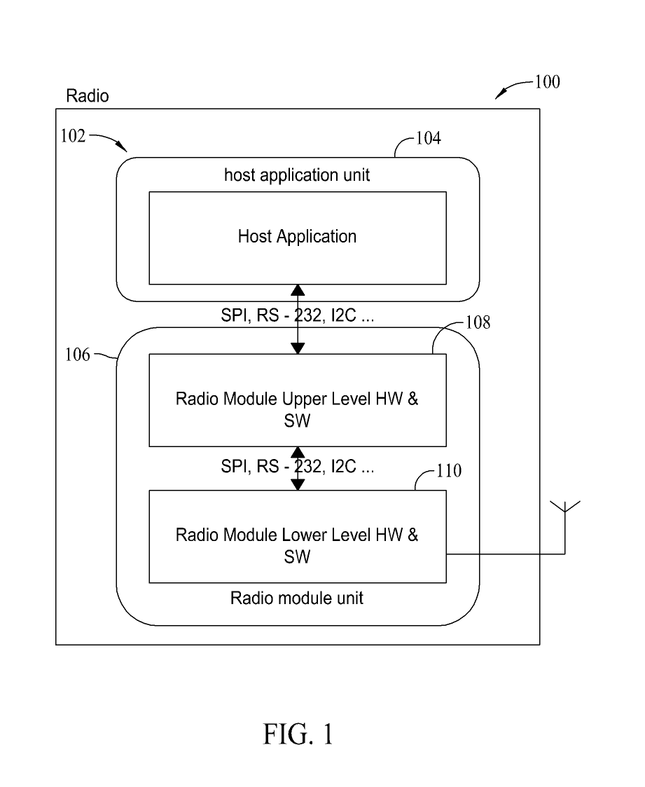

FIG. 1 illustrates an exemplary radio device 100 having an exemplary radio system architecture 102 therefor. As shown in FIG. 1 the radio device 100 generally includes two major functional units, namely a host application unit 104 and a radio module unit 106.

The host application unit 104 is the actual application implementation for which the radio device 100 is used. That is, the host application unit 104 implements the application logic and state machines that control the radio module unit 106 and also provides a user interface to the outside world. In the context of the Open System Interconnection Reference (OSI) Seven Layer Model, the host application unit 104 implements layers 7 to 5 (i.e., the application layer, the presentation layer and the session layer). From a hardware perspective the host application unit 104 may reside on a separate hardware platform with a dedicated application processor or programmable logic controller (PLC) and a known serial hardware interface to enable communication with the radio module unit 106.

The radio module unit 106 implements the actual radio control protocols and base band configuration and corresponds to layers 4 to 1 in the OSI Seven Layer Model (i.e., the transport layer, the network layer, the data link layer, and the physical layer). As shown in the example of FIG. 1, the radio module unit 106 includes two functional units, namely a radio module upper level hardware and software layer 108, referred to herein as an “upper layer”, and a radio module lower level hardware and/or software layer 110, referred to herein as a “lower layer”.

From a software perspective, and again referring to the OSI Seven Layer Model, the upper layer 108 may implement the transport layer, network layer, and data link layer including Media Access Control (MAC) and Logical Link Control (LLC), which functionally includes data routing control logic and Frequency Hopping Spread Spectrum (FHSS) control logic for radio operation. The radio module lower layer 110 implements the interface to the radio physical layers that functionally sets actual radio frequencies and samples, and modulate/demodulate radio signals according to upper layer logic.

From a hardware perspective the upper layer 108 may include its own dedicated processor with a known serial hardware interface that allows communication and control over the lower layer portion of the radio module 106. The lower layer 100 may also include its own dedicated DSP processor that implements sampling and modulation/demodulation algorithms to a simple serially controlled synthesizer component with no software processing ability. The upper and lower radio layers 106 and 110 may further share the same hardware printed circuit board. Various other processor and circuit board arrangements are also possible as those in the art would understand.

Such a radio device 100 is commonly used for monitoring and control purposes in, among other things, Supervisory Control and Data Acquisition (SCADA) systems. SCADA systems typically include a number of remotely monitored locations including sensors, and data and information associated with the sensors at each of the remotely monitored location are communicated to other locations in the system, and ultimately to a centralized computer system that manages data collected and controls operation of the system. Control commands can likewise be sent to the remote locations using a communications network. The radio device 100 may be configured for so-called short range or long-range radio communications of data and information in a wireless manner.

As mentioned above, known industrial radio devices tend to be rather customized, both in terms of hardware and software, for specific end use applications such as SCADA systems and the like. That is, industrial radios are somewhat uniquely designed for communication of particular amounts or types of data using a particular network communications protocol. Of course, many communication protocols exist, including proprietary protocols, and a good deal of variation in sophistication in the functional requirements of the radio devices exists across different end use applications. It is therefore perhaps unsurprising that unique and customized industrial radio products have become the norm in the industry.

For industrial radio providers, a proliferation of customized radio devices presents practical challenges. Specifically, existing radio devices are generally not easily adaptable for other users and for use with different radio systems for which they were designed. As such, intensive re-engineering of radio devices is often required that would preferably be avoided.

Considering the exemplary radio architecture shown in FIG. 1, even for radio devices 100 having similar architecture and used in combination as a family in a common end use or application, a large amount of variance between different radio families and even between radios in the same family typically exists. For example, different processors and subsystem components that are widely available may be used to implement the radios 100. Different radios 100 may be provided for different purposes (e.g., mobile versus fixed communications) and with different functional and performance abilities (e.g., Full duplex communication, half duplex communication, varying data rates) and also for different end users and cost considerations. The above factors may result in hardware and software development differences across different radios 100. Different processors dictate different hardware interfaces for cross board communications, different register sets, different processing capabilities and different performance and timing considerations for every radio 100. This in turn dictates changes in the software layers that are put into the different radios 100.

Conventionally, each radio 100 and radio family is developed as an independent entity, with an independent software and hardware architecture and different software layering and functionality considerations. Substantial constraints and difficulties are therefore presented when attempting to employ a host application 102 to a different radio module unit 106 other than the one it was initially designed for, as is sometimes desirable. As a result, an application development team is required to make extensive efforts to understand the differences (hardware and software) between an initial radio module that the host application 104 was designed for and a new radio module that the application 104 is desirably used with. In such a situation, the application development team must effectively “re-engineer” a host application to work with a different radio module because the software for the host application layer 102 is not re-usable with other radio module units without intensive modification.

These and other difficulties are effectively overcome with an exemplary unified Radio Programming Interface (RPI) system, software, and methods explained below. The unified RPI eliminates the direct dependency between a specific host application unit 104 and a specific radio module 106. A standardized and largely universal radio interface is therefore realized that does not change from the application point of view and will enable reuse of different host applications with different radio modules in almost the same manner with minimal differences and effort required by application engineers, thus reducing the time to market for re-engineered products and increasing software reusability.

As will become evident below, the exemplary RPI includes a software stack enabling swift and standardized integration of host radio application units 102 with different physical radio module units 106. The RPI additionally facilitates a methodology for the development of future radio platforms in a standardized manner, achieving considerable reduction in new radio development time and expense.

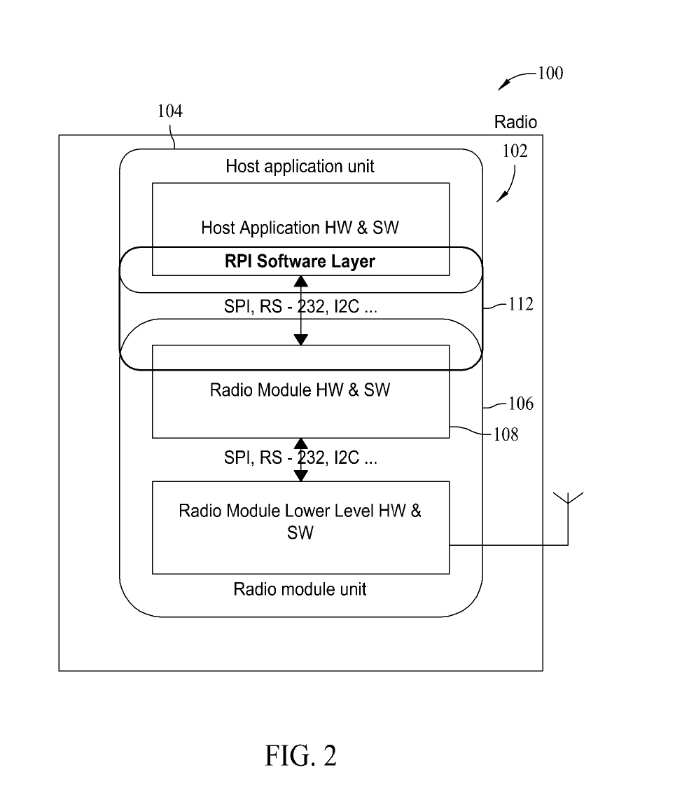

FIG. 2 illustrates an RPI software layer 112, sometimes referred to as a software stack, residing between the host application unit 102 and the upper layer 108 in the radio device 100. The RPI layer 112 is basically divided between these two entities 102, 108 and its operation is based on their hardware and software resources. The RPI layer 112 is sometimes referred to as a software stack and provides a number of benefits including at least the following.

The RPI software stack in an exemplary embodiment provides software portability amongst different radio devices. That is, the RPI software stack is provided as a cross platform portable software stack for radios. In an exemplary embodiment, the RPI stack is written in the C programming language following Ansi-C standard guidelines, although other programming languages and/or applications of other standards or guidelines may be utilized if desired.

The RPI stack is also operating system independent in an exemplary embodiment, and accordingly does not rely on any assumptions as to the existence or lack of a Real Time Operating System (RTOS) on the target host platform.

The RPI software stack is configured to support a variety of different processors, such as 8-32 bit processors in an exemplary embodiment, and thus is generally not processor dependent.

The RPI software stack is also not dependent upon and does not make any assumptions as to the hardware interfaces of the target host platform. Rather, the RPI software stack will publish the hardware services it requires in order to function properly. Actual implementation of those hardware services, however, is not part of the RPI software stack and it is up to the application developer to provide these services to the RPI software stack.

The RPI software stack is modular and enables inclusion/exclusion of new or not required parts of the stack, thereby minimizing memory usage on different target platforms.

The RPI software stack has a relatively small code and CPU footprint from the host system.

The software stack includes a simple usage methodology that is partly explained and partly apparent below.

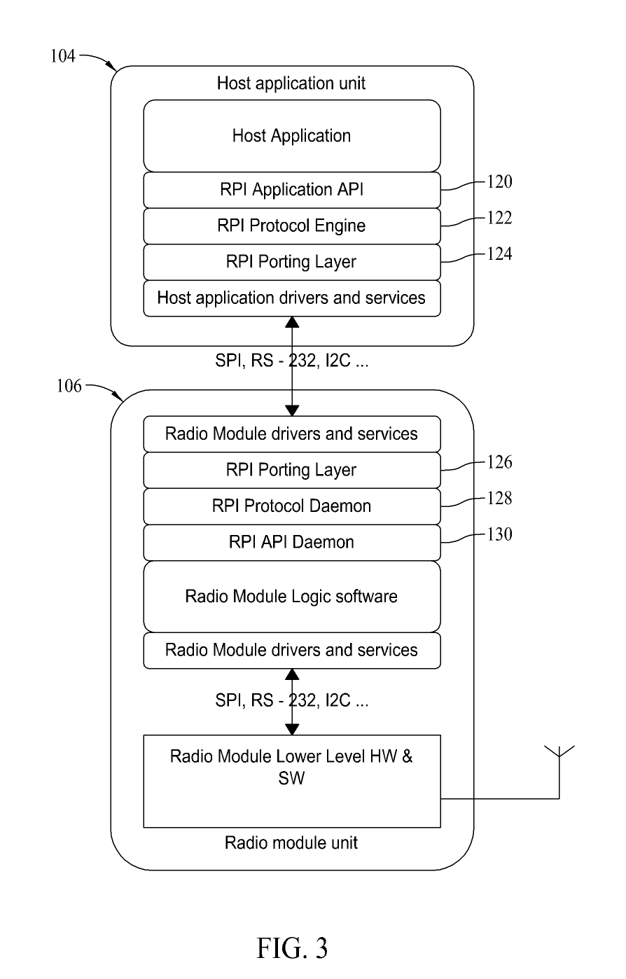

FIG. 3 illustrates integration of the RPI layer/software stack 112 in further detail.

As shown in FIG. 3, the RPI software stack incorporates three basic functional layers on each side of the host application unit 104 and the radio module unit 106. On the host application side, the RPI stack includes an RPI Application RPI layer 120, an RPI protocol engine layer 122, and an RPI porting layer 124. On the radio module unit side, the RPI stack includes an RPI porting layer 126, an RPI Protocol Daemon layer 128 and an RPI API Deamon layer 130.

On the host application side the Application RPI layer 120 ensures radio module uniformity from the point of view of the application engineers. On the radio module side the RPI API Deamon layer 130 handles the different radio resources and logic in the manner that is required by the host application module 104.

The RPI protocol engine layer 122 serves as a control and data transfer layer defining a “common language” for all module interaction ensuring that commands/data sent by a host application module 104 are understood in the same way by different radio modules 106 and vice versa. The implementation of the commands sent from a given host application module 104 to a given radio module 106 will, of course, vary from one radio module 106 to another based on the capabilities of the radio particular radio module selected.

The RPI porting layer 126 serves as an interface between the RPI software stack and the hardware and software resources of actual printed circuit board that it resides on. The RPI software stack, for example, will require services for serial data transfer from one module to the other, and timer services. The RPI porting layer 126 specifies the required RPI services and serves as a board porting layer for the application engineers.

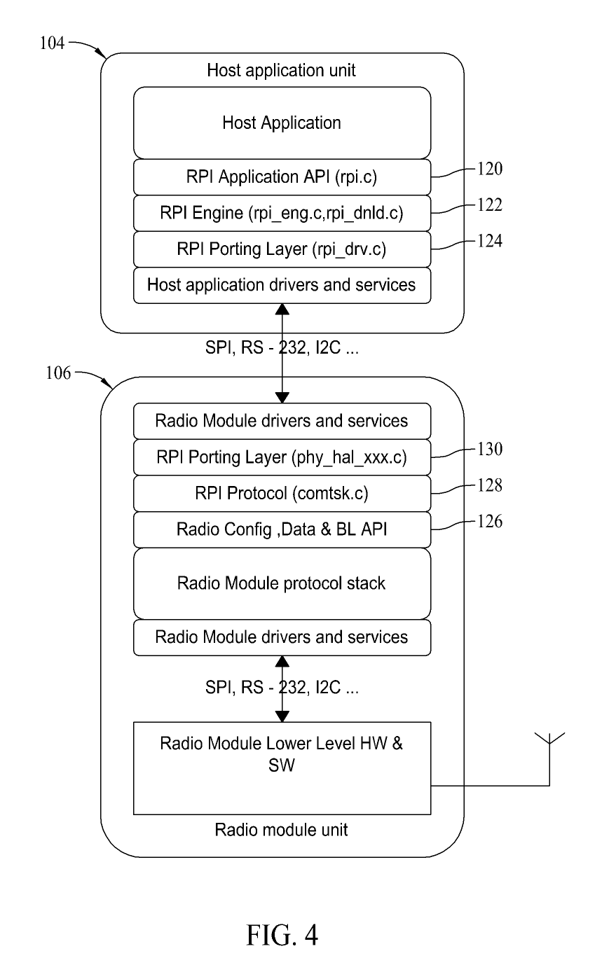

The functional division of the RPI software stack is illustrated in FIG. 4. As shown in FIG. 4, the functional division exists also at a source code file level. On the host application unit 104 in this example, the application API layer 120 is implemented by the rpi.c file, the protocol layer 122 is implemented by rpi_eng.c and rpi_dnld.c files and the porting layer 124 is implemented by the rpi_drv.c file.

Continuing with the example shown in FIG. 4, on the radio module unit 106, the application API layer 126 is implemented by the protocol stack and configuration files, the protocol layer 128 is implemented by comtsk.c file and the porting layer 130 is implemented by the phy_hal_XXX.c files.

The host application unit 104 interacts only with the RPI application API layer 120. Application developers need to port serial drivers and a timer services to comply with the services needed by the RPI software stack.

Exemplary conventions for the RPI Software stack system resources and services requirements, and general operating definitions and assumptions that need to be clarified when porting the RPI software stack on the host application include the following.

The RPI software stack in one embodiment uses the basic C language types. Table 1 below specifies exemplary assumed type length in bits:

TABLE 1

| Variable Types | Length (Bits) |
|---|---|
| char, unsigned char | 8 |
| short, unsigned short | 16 |
| Int, unsigned int | 32 |
| Long, unsigned long | 32 |

All multi-byte binary values are transferred in Little Endian order (i.e. LSB first) in an exemplary embodiment. This does not apply, however, to string variables.

The RPI Stack code is not re-entrant code in an exemplary embodiment. It is therefore up to the application developers to ensure proper synchronization measures are taken when using multi process access or OS tasks.

The RPI software stack in one exemplary embodiment requires the following memory allocations on the host application unit (based on the Microsoft VC++ compiler and linker in this example): code memory of about 13.5 KB with no optimization or about 10 KB optimized for speed or 7.5 KB optimized for space; Data Memory of about 4.5 KB; and minimal stack size of about 50 B. Of course, one of these characteristics may vary accordingly with varying requirements for the communication protocol selected and other features and functionality of the radio device itself and/or the RPI software stack.

The RPI software stack function calls at any direction (RPI to host application or host application to RPI) always end with an empty function in an exemplary embodiment. When sending a request to the radio module 106 the function call chain starts with the RPI API layer 120 and ends with the porting layer 130 functions that send a byte stream to the radio module 106. In the opposite direction, radio module indications and responses will always end up at an empty RPI API response function in the RPI API layer 120.

The application developer in an exemplary embodiment writes code at both ends in order to utilize the data sent from/to the RPI software stack. Therefore, in the context of the RPI software stack the application is blocked only for the amount of time it takes to translate an application request to a byte stream output or a byte stream input to a valid response form by the RPI software stack. The application will be blocked for additional amount of time (if at all) based on the application developer code executed at both ends of an RPI function calls.

To clarify this a simple example (Host application to RPI) is illustrative in which the application calls a RPI API radio configuration function which is to be sent to the radio and change its configuration. In this case the application will be blocked by the RPI for the amount of time it takes to parse the request form and send it to the RPI driver abstraction layer. At this point the application developer's serial driver code will be called and based on the implementation of this driver the application will blocked for additional time.

In general, there is no blocking by the RPI software stack from the point of sending a request to the radio module until getting back a response from the radio module.

In an exemplary embodiment, the RPI software stack will require the following exemplary services from the host application: send one byte to the radio module; receive one byte from the radio module; Read File chunks from the application file system; and one timer with msec resolution supporting the following functionalities: (i) Start timer; (ii) Stop Timer; (iii) Call timer expiry function. Timer functionality and reading file chunks will be required for radios that will need to use RPI software stack firmware image download services. Additionally, and also optionally, a functional porting interface is provided in some embodiments in order to change the serial transfer data rate on the host serial interface in order to support a firmware download feature. For example, if the host application unit 104 includes an RS-232 serial hardware interface, an application developer will need to provide the RPI software stack with an implementation for changing the baud rate of the hardware interface to support firmware downloading functionality.

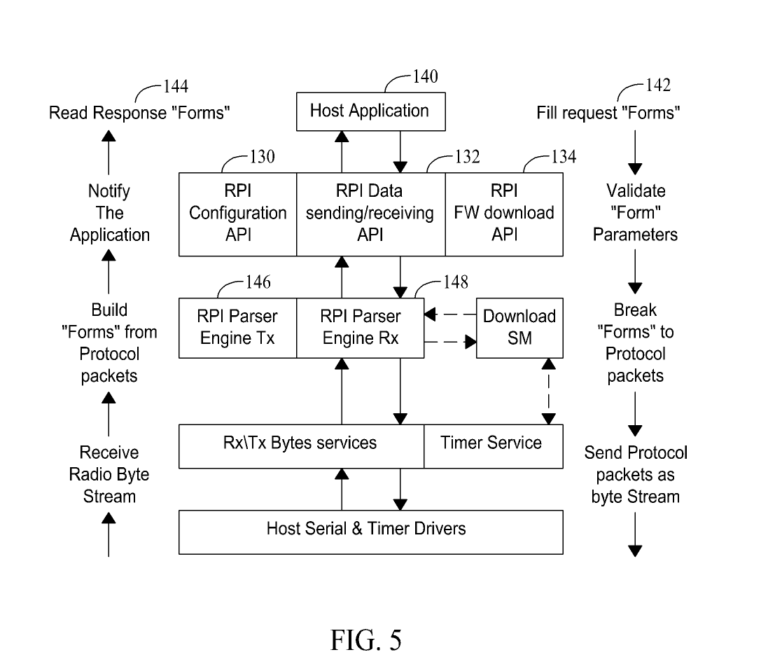

As shown in FIG. 5, the RPI software stack is built out of three basic layers each providing different functionality. The RPI API Breaks down to three major API's based on functionality, namely the configuration API 130 (local and remote radios), The data send/receive API 132, and The firmware download API 134.

As further illustrated in FIG. 5, the host application 140 communicates with the radio by sending request “forms” 142 and receiving back response “forms” 144. As used herein, and as one example, a “form” is basically a C-structure with pre-defined fields that the host application 140 needs to fill and submit to the RPI API in case it needs a service from the radio module 106. The radio module's response is submitted back to the host application as a response form 144.

Upon receiving a request form the RPI API 130, 132 or 134 validates the form parameters filled by the user application software and then sends the request form to the RPI parser engine Tx side 146 with a parsing function index. The parser engine 146 looks for the right parsing function to call based on this index and parses the request form into a radio protocol packet. After assembling the protocol packet it is sent as a byte stream using the send\receive byte services ported to the host unit serial drivers by the application developer.

On the opposite direction, whenever the radio module sends a response to the host unit it is received as a stream of bytes via the host unit drivers which forward every byte to the RPI send\receive byte services porting layer. The RPI porting forwards received bytes to the RPI engine parser Rx side 148. The RPI engine parser collects the bytes until it can assemble a valid radio protocol packet. At this point the RPI engine calls an RPI engine response function which parses the radio protocol packet into a response form. When the response form is ready the RPI parser engine will call the relevant RPI API response function in order to notify the host application about the radio response.

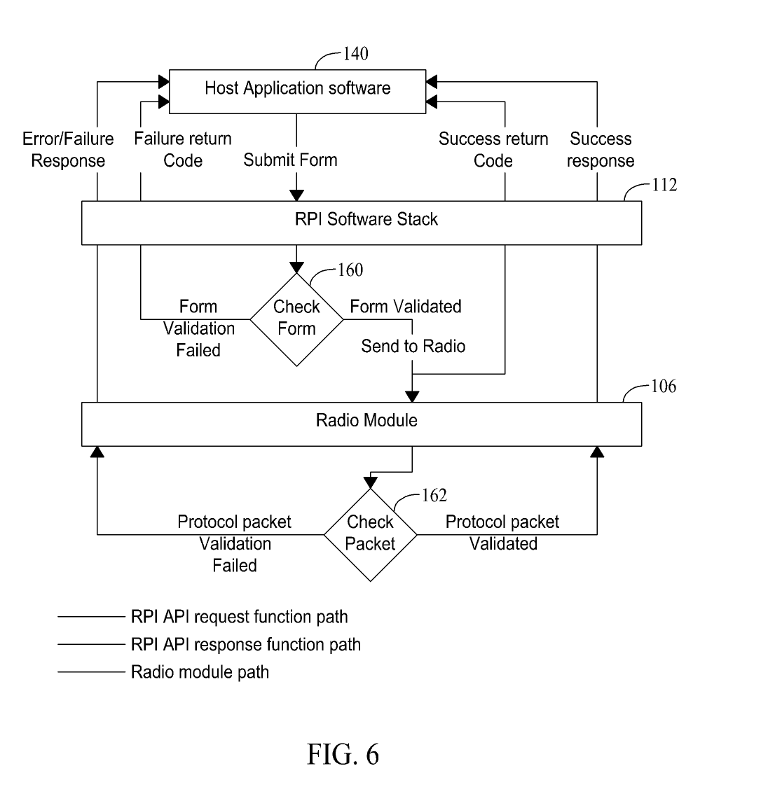

As shown in FIG. 6, when sending a request to the radio module 106 responses are returned to the host application 140 at two levels. At the first level, RPI API functions return a success/failure status to the calling function upon their return. A failure status is returned whenever the application form parameters fail validation when the form is checked as shown at step 160. Success status is returned when ever the form parameters pass the RPI API parameter validation and the request was forwarded to the radio module 106. At this point the application can make a new request to the RPI API and reuse the form buffer. Insofar as the RPI is concerned, however, success status does not guarantee that the sent request will be carried out by the radio module. Rather, the success status only means that a valid request was forwarded.

The radio module 106 upon receiving a valid request from the host application 140 validates its content as shown at step 162 before it is carried out. This validation includes a (cyclic redundancy check) CRC and request content validation. If the packet validation fails an error response is sent back to the host application 140. If the validation succeeds when checked at step 162 then a success response will be sent back to the host application 140 if the request was a configuration or download request. For data sending requests no response is sent back upon success in an exemplary embodiment.

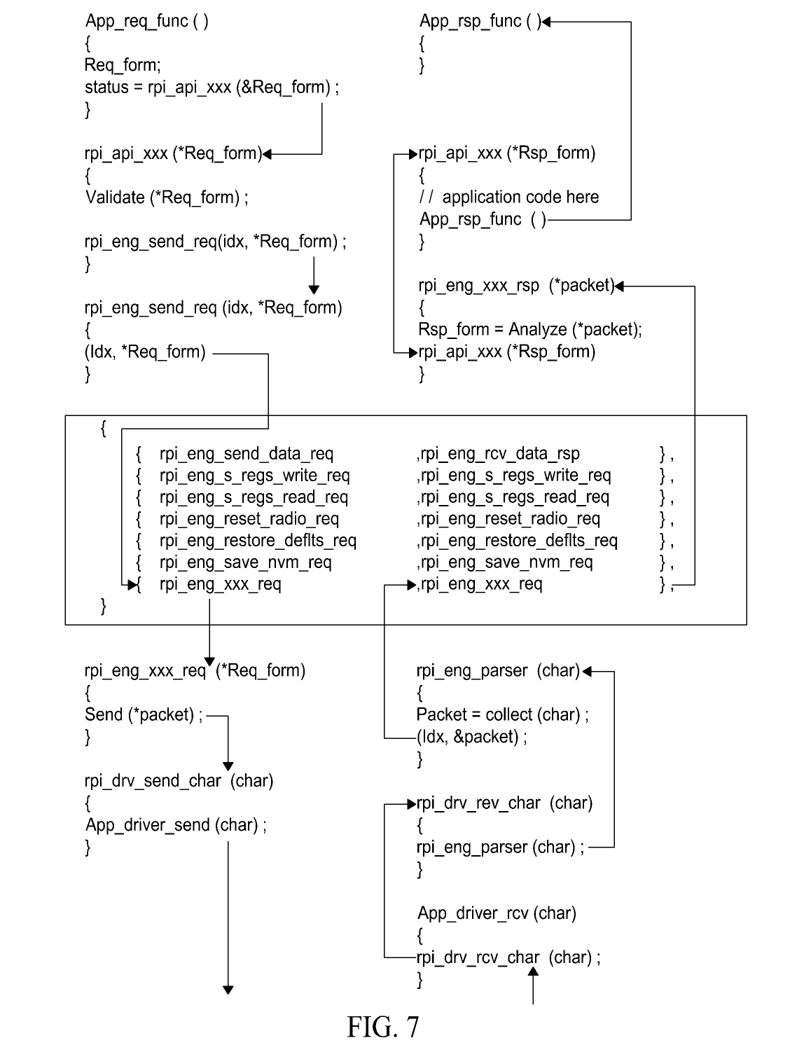

As shown in FIG. 7, the RPI software stack is designed to emphasize software modularity and ease of adding or removing new or unneeded parts of the software stack with minimal impact on the application software. In the example shown, the RPI software stack has four levels of software modularity that enables the application developers to utilize the stack to best meet their system needs. The four levels of modularity of the RPI stack include Removing/Adding a functional layer, Removing/Adding a functional API, Replacing the radio protocol parser and Removing/Adding already existing API with unneeded/new parameters

To fully understand the RPI software stack modularity some additional details deserve some focus. At the highest level of the RPI software stack is the RPI API. This API is made out of two types of functions: API request functions and API response functions. API request functions are the functions that the application software calls when it wants to communicate with the radio module 106. API response functions are called by RPI parser engine to notify the application software 140 of a radio response to a previously made request or as an indication of a radio event. Both types of functions are organized in groups according to functionality and receive predefined C structures as their parameters that are referred to as “forms”. When the application software calls an API function and submits a request form, the API layer of the RPI stack basically validates user request form and submits it to the RPI parser engine layer based on a fixed index.

At the RPI parser engine level there is a fixed table of request function pointers that correspond to the RPI API index. These functions take the RPI API forms and break them into protocol packet messages to be sent over the porting layer as a stream of bytes.

On the other side, when the radio module 106 sends a response/indication protocol message, the byte stream is sent over the RPI porting layer and collected by the RPI parser engine to the point it is a valid radio protocol message. Once the protocol message is decoded, the RPI parser engine uses an index to point to a response function inside a response function table. The response function will break the protocol message into a form and submit it to the RPI API layer that will notify the application software of the new response/indication.

As previously noted, the RPI software stack is built out the RPI API, RPI parser engine layers and the RPI porting Layer. These layers are well defined in terms of their functionally and indexed approached via function pointers tables. This makes it relatively easy to the application developer to remove/replace a layer. Also, adding new layers on top of the RPI API or below the porting layer requires minimal effort.

The RPI functions are grouped by functionality and therefore when functionality is not required anymore and the application developer wants to reduce the code/data size, the functionality can be easily removed from the RPI API and the RPI parser engine. As FIG. 7 shows, all that is needed in order to remove functionality from the RPI software stack is basically to remove the relevant API functions from the RPI API and remove the parsing functions and their indexes and entries in the RPI parser engine layer function pointer tables. Adding new functionality follows the same logic in reverse order.

In an exemplary embodiment, the host application radio protocol for RPI is a proprietary protocol OMNEX Control Systems ULC, Vancouver, British Columbia, Canada. Application developers may, however, keep the same functionality of their applications and define a new protocol parser at the RPI parser engine level in other exemplary embodiments. Since the approach from the RPI API layer to the RPI parser engine layer is index based, the RPI API layer and the Application software do not change when a protocol is changed. This of course would mean writing new parser functions and placing them in the correct indices of the RPI parser engine function table, and, implementing the new protocol also at the radio module side.

The fact that the RPI API function calls do not use specific parameters but rather use pointers to C-structures (known as forms) allows the application developer to take off/add parameters with out changing the API the application calls when ever it is required to widen/narrow the API.

The RPI software stack implements a few state machines and processes that are required for the RPI software stack in order to carry out different functionalities provided. The main state machines and processes found in the RPI software stack on the host side include Local Radio Configuration process, Remote Radio Configuration process, Data sending process, RPI engine receive side parser engine state machine, and RPI local Firmware download process and state machine

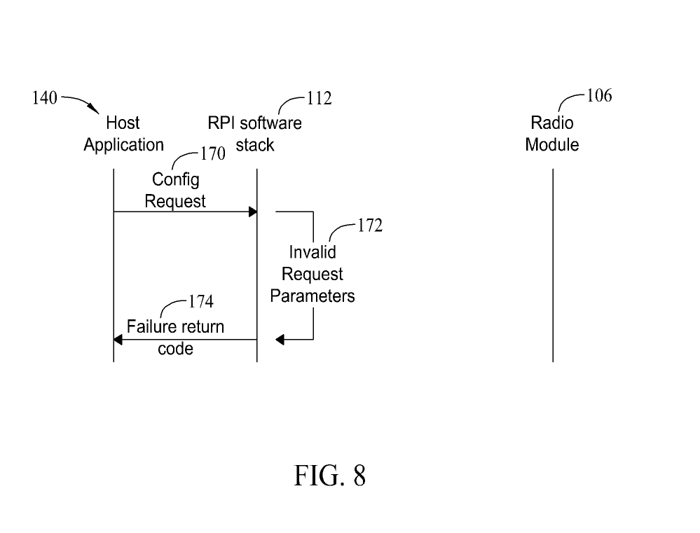

As shown in FIG. 8, configuration of the local radio module 106 is a two level process. After the host application 140 sends the configuration request 170 the first level of the RPI software stack (RPI API) 112 validates the correctness and ranges of the configuration parameters. If the configuration parameters are invalid as shown at 172 an immediate failure return code 174 is sent back to the host application 140 and the request 170 is not sent to the radio module 106.

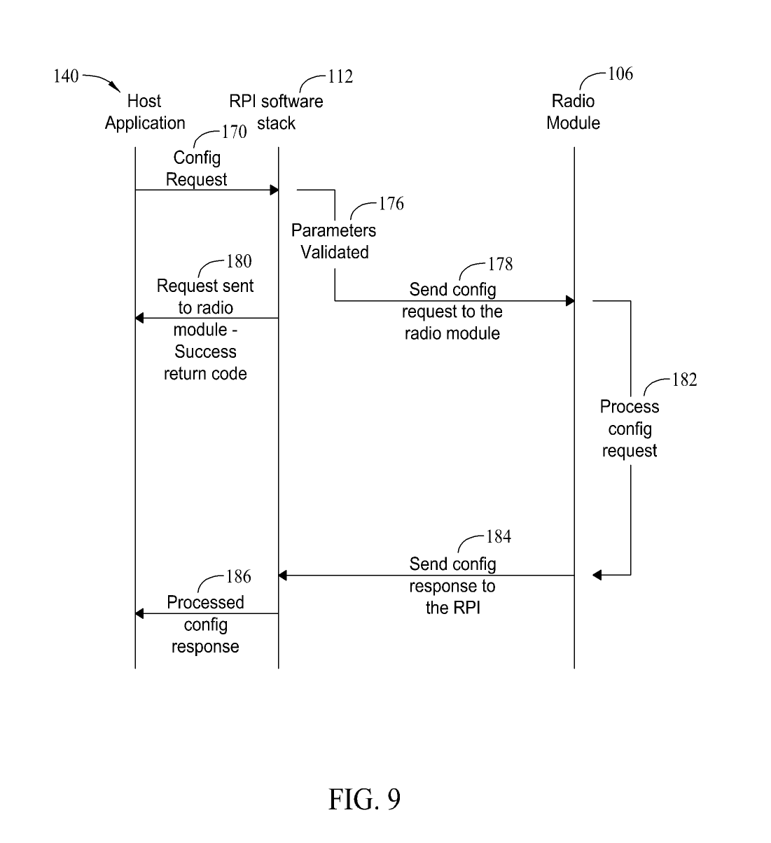

As shown in FIG. 9, if the configuration request parameters are validated as shown at 176 by the RPI software stack 112 the request 170 will be forwarded to the radio module 106 as shown at step 178, and a success return code 180 will be returned to the host application 140. This success code 180 comes to indicate that the request has passed the RPI validation and was sent to the radio module 106 for further handling. As mentioned above, the success code 180 indicates only that the request was sent to the radio module 106, and does not necessarily indicate that the request was actually carried out.

At the radio module side the configuration request is validated and then processed as shown at 182. A configuration response 184 is sent back to the RPI software stack 112. The RPI software stack 112 processes the radio module response and sends it to the host application 140 as shown at 186. At this point the host application 140 needs to analyze the radio response and understand if the configuration response was successful or failed.

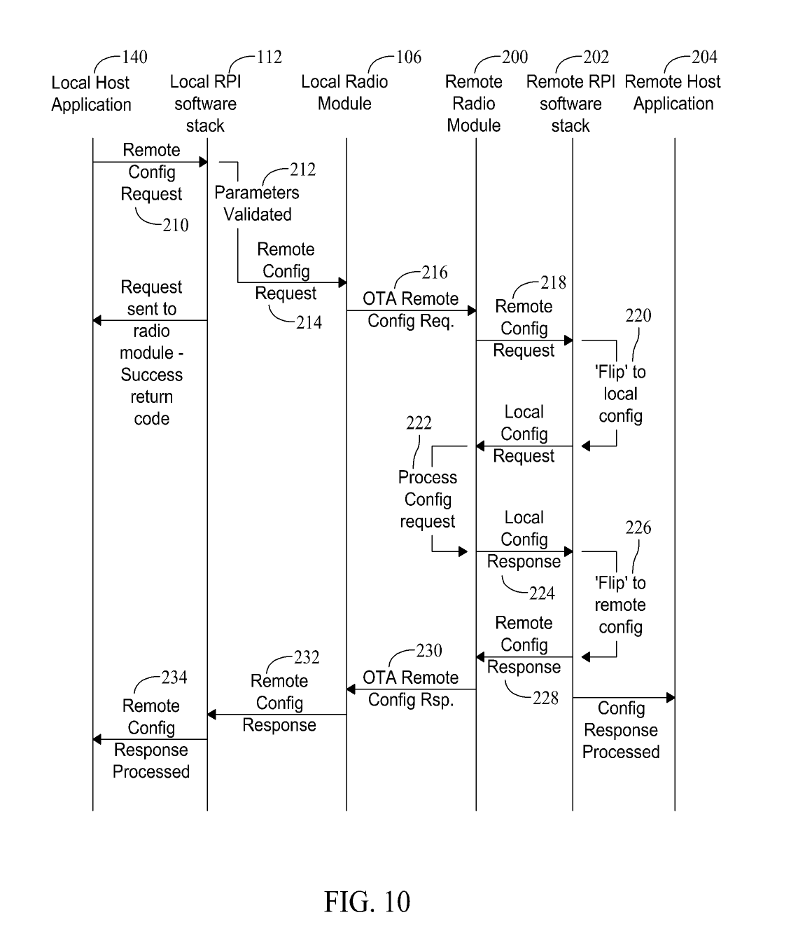

As shown in FIG. 10, the configuration of a remote radio module 200 is a distributed process that is split between the local radio 106 and the remote radio 200 (the radio that is to be configured). The remote radio 200 includes, as shown, its own RPI software stack similar to the stack 112 of the local radio module 106. The remote radio 200 also includes, as shown, a remote host application 204.

Remote radio configuration process starts the same way as local configuration (FIG. 9) by sending a configuration request 210 to the local radio module 106. In the remote configuration request 210 the radio address field of the request form is set to the actual address of the remote radio module 200 to be configured, instead of the local radio address identifier in the local configuration request 170 (FIG. 9).

The remote configuration request 210 goes trough the same validation 212 as the local request and can fail immediately if its parameters does not pass the RPI software stack validation as explained in relation to FIG. 8 above.

If the parameters pass the RPI stack validation 212 the request is forwarded at step 214 to the local radio module 106.

When the local radio module 106 receives the remote configuration request 210 it does not handle it but rather sends it over the air (OTA) to the remote radio module 200 as shown at step 216. When the remote configuration request arrives to the remote radio module 200 it is sent to the remote RPI software 202 stack on the remote host unit to be analyzed as shown at step 218.

The remote RPI stack 202 changes the remote configuration message from a remote configuration request to a local configuration request and sends it back to the remote radio module as shown at step 220 and referred to as flipping the request. The remote radio module 200 then processes the request as a local configuration request at step 222 and sends a response back to the RPI software stack 202 on the remote host unit 200 as shown at step 224. Upon receiving the response from the radio module 200 the remote RPI stack 202 sends back the response to the local radio module 106 as shown at steps 226, 228, and 230. It also sends a copy of the response to the remote host application 204 (via the remote RPI software stack 202) to alert it that its radio module 200 was remotely reconfigured.

At the local radio module 106, upon receiving the remote configuration response at step 230, the local radio module 106 forwards it to the local RPI software stack 112 which in turn forwards it to the local host application 140.

It is important to understand that since the local and remote configuration processes are stateless it is up to the host application to create the state machine to roll out of possible erroneous situations.

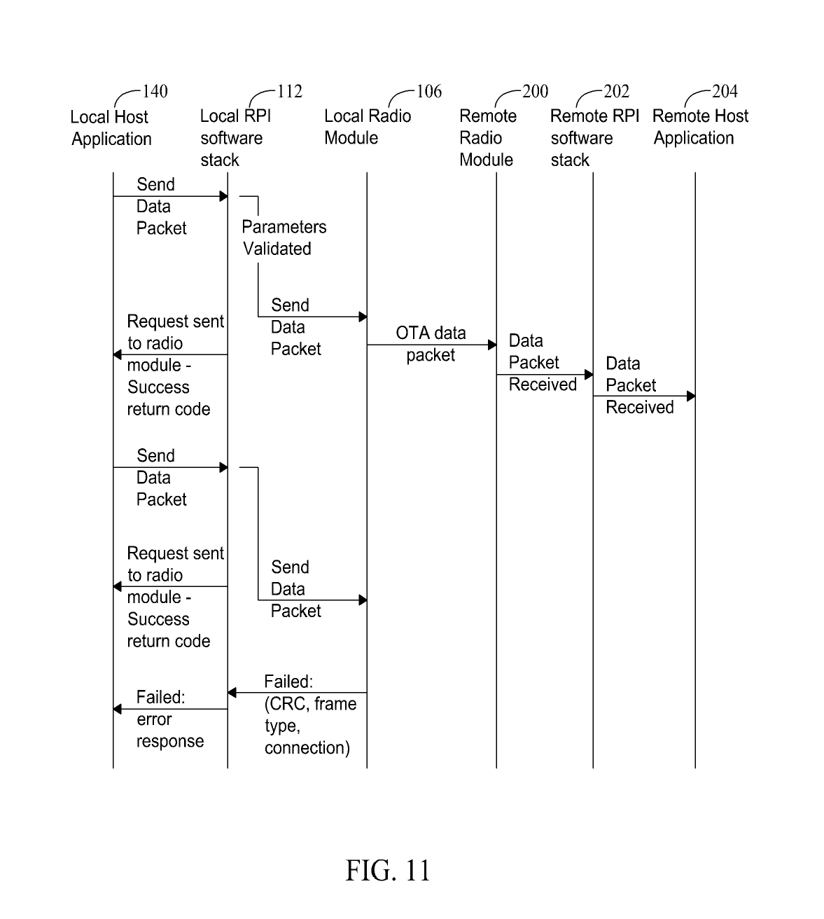

As shown in FIG. 11, sending data packets using the RPI is a straight forward process. As in the local configuration process also data packet send request is validated at two levels, first a parameters validation by the RPI software stack and then further validation by the radio module.

The difference between sending data process and local configuration process is in that the radio module will send a response to the application only if the send data process fails. In case of a success no response is sent back to the host application. Reasons for send data failure could be CRC error, Unknown frame type or the requested connection to send data was not opened by the application software.

As shown in FIG. 11, the RPI software stack implements a binary protocol, which may be proprietary in some embodiments, when exchanging messages with the radio module. Data sent from the host application side built into a protocol messages which are sent as a byte stream over a serial connection to the radio module. The radio module responses are sent to host application over the same serial connection also as byte stream.

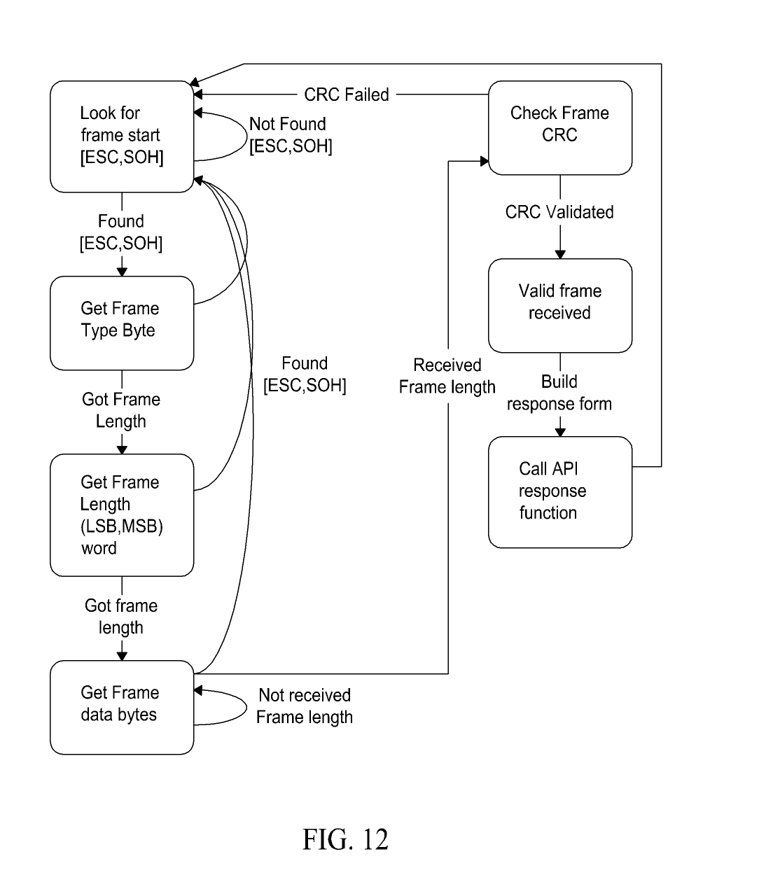

As shown in FIG. 12, the RPI software stack parser engine builds these byte streams into protocol messages and then calls the proper RPI engine functions to parse these protocol messages into application layer forms. FIG. 12 illustrates the RPI parser engine state machine that parses the byte stream sent from the radio module to a valid protocol message.

The RPI software stack 112 has a radio image download capabilities for usage with radio modules 106 that have a boot loader application as part of their interface. In order to use RPI's download capabilities the radio module boot loader must conform to a pre-defined boot loader message format that an application engineer may choose.

In order for the application software to use the RPI's download capability it needs to have the file to be downloaded at a memory location that is accessible to the RPI software stack. It also needs to provide a timer service as it is required for the download state machine implementation.

Downloading an image to the radio module can also be done without providing a timer service to the RPI. When using such an approach, however, the application software needs to handle all the erroneous situations that might occur during the download of the radio image.

To initiate a download process the application needs to provide a pointer to the image file (or a service for reading file chunks from the application files system), its size and an identifier telling the RPI software stack to which of the two flash banks on the radio module to download the radio module image file. The radio module file can be downloaded to the executable bank replacing the current radio image running or to the radio module's secondary bank. This is done by submitting a firmware start download request via the RPI API to the radio module boot loader. Submitting this request (or any of the boot loader requests) is possible only shortly (within 1 seconds) after a radio module reset when the radio module boot loader is expecting commands from the host application.

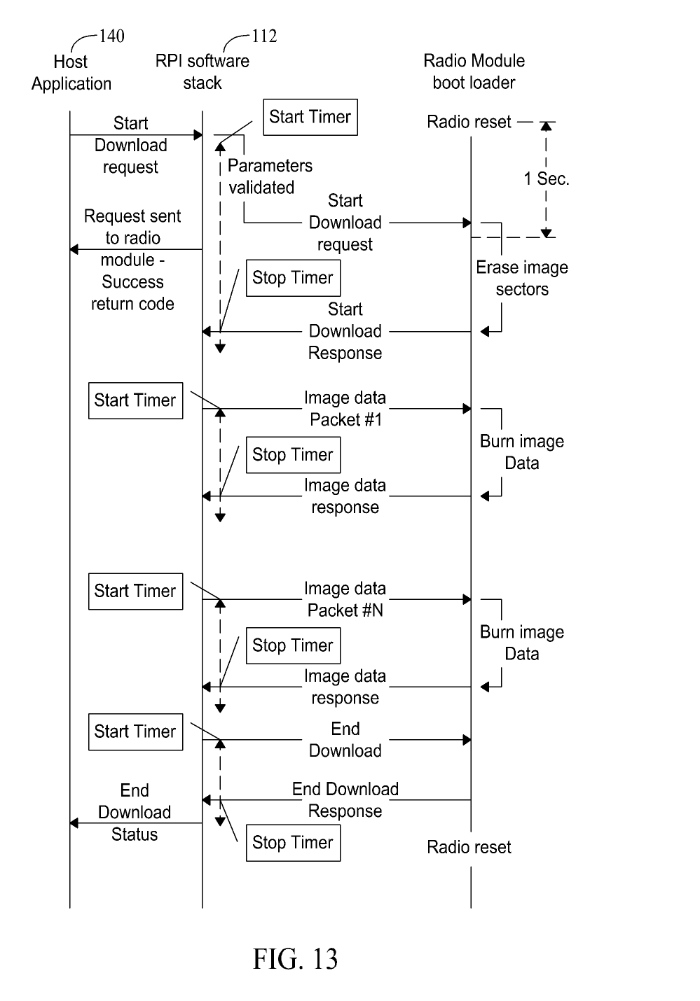

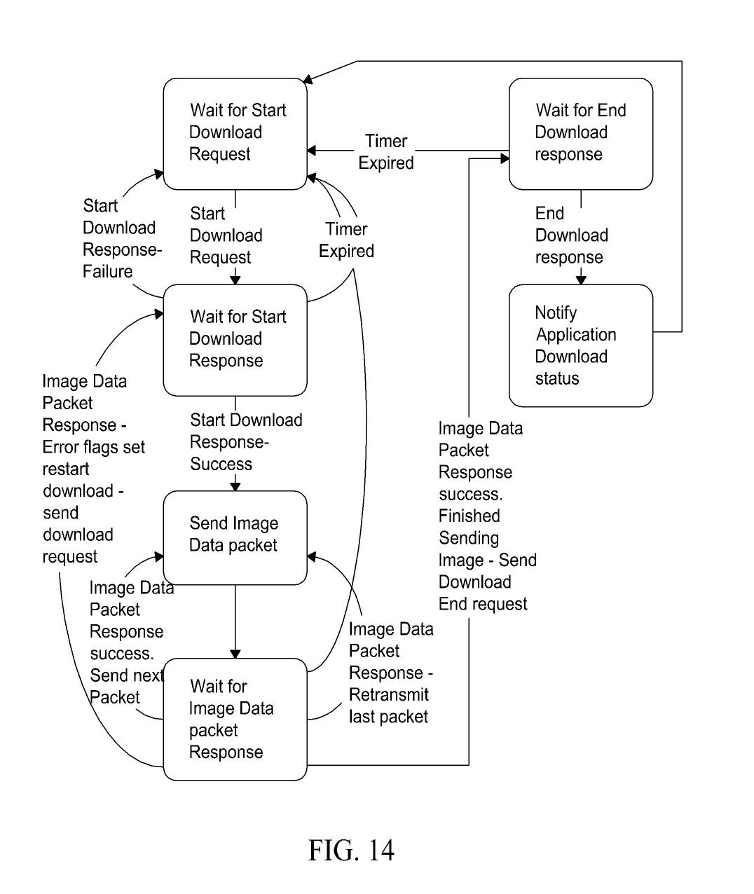

Once these parameters are provided to the RPI software stack at the correct timing window, it will send them to the boot loader to initiate a download process. The boot loader will send back a response to the RPI software stack specifying if the start download request is successful and image download can commence. If the start download request was successful, the RPI software stack will handle all aspects of radio module image download and will notify the host application in case of errors or a successful end of the download process. Shortly after a radio image successful download procedure the radio module will be reset by the boot loader sending a reboot response message to host application via the RPI software stack. An exemplary download process and state machine are shown in FIGS. 13 and 14.

The RPI software stack follows code conventions such as those described above. There are, however, a few code conventions that are added in the RPI software stack in order to create a methodology that is easy to follow and implement and helps the application developers to find their way around the RPI software stack. The following code conventions are therefore implemented by RPI software stacks in an exemplary embodiment.

First, all RPI software stack functions include the following prefix: rpi_layer_xxx where layer is the one of the 3 RPI layers (“api”, “eng” or “drv”) and xxx is the function description. For example: rpi_api_s_regs write, rpi_eng_parser or rpi_drv_rcv_char.

Second, all RPI API request functions return with rpi_api_status return code. For example: rpi_api_status rpi_api_send_packet (data_packet_req*p_packet_data).

Third, all RPI API response functions return with no return code. For example: void rpi_api_receive_packet(data_packet_rsp*p_packet_data).

Fourth, all RPI API functions receive a pointer to a C-structure as their only parameter. This Cstructure is what is referred in RPI API terminology as a form (see examples above).

Fifth, forms defined as request forms will have a “req” suffix for the structure definition. For example: data_packet_req*p_packet_data.

Sixth, forms defined as response forms will have an “rsp” suffix for the structure definition. For example: data_packet_rsp*p_packet_data.

Seventh, RPI Stack version appears in the file header of every “*.c”, “*.h” file with the “@version” prefix and then “RPI x.xx” string. For example: @version RPI 1.01.

Having now described the RPI functionally in some detail with reference to various examples, the RPI may be implemented conventionally using appropriate data structures and calls in a computer program embodied on a computer readable medium and having segments of code or instructions executed by one or processors in a radio device that correspond to the various RPI functions and features described. In other words, the RPI may be provided on a computer program product having a readable memory device including computer program logic instructions encoded thereon that, when performed on a processor in a radio device including a host application unit and a radio module unit, such as those described above, provides a method for performing the operations in the methodology also described above.

It is understood that additional segments of code corresponding to functions not described in further embodiments, and further that not all of the exemplary functionality described need be used in some embodiments of the invention.

The technical effect of the state machines, processes and systems described herein is achieved when the RPI stack 112 is installed downloaded or otherwise accepted by the radio devices described herein for execution by the processor(s) in the radio device to achieve the functional aspects described.

Various adaptations of the RPI software stack described may be utilized to coordinate any of the following exemplary radio communication scenarios:

Communication between one host application 140 to one radio module 106 may be handled by the RPI stack 112. This is the most common and simplest usage for the RPI software stack 112. In this use case every host application 140 controls only one radio module 106.

Communication between one host application 104 to many radio modules 106 may be handled by the RPI stack 112. In this use case every host application 140 controls more than one radio module 106. It is up to the host application 140 to multiplex and route the data sent and received via the RPI software stack 112.

Communication between a “Smart” Control application and “Smart” Endpoints may be handled by the RPI stack 112. In this use case every host application 140 controls the radio module 106 in the same way and the application units 102 have processing power and logic to handle the full scope of RPI events and functions described.

Communication between a “Smart” Control application and “Dumb” Endpoints. In this use case one host application 140 handles the full scope of the application control and logic while the end point application units have limited to logic which is used to carry out basic RPI functionalities. An example of this kind of a system is an environment control system where the main application collects data from remote simple wireless sensors. The main application can also remotely configure the different sensors based on the application logic.

Software Development Kit (SDK) conversions to proprietary radio protocols or radio modules 106 may be handled by the RPI stack 112. The RPI stack 112 can also serve also as an SDK for demo/product development by a third party based on a proprietary radio module.

The benefits and advantages of the inventive concepts are believed to be amply illustrated from the various embodiments disclosed.

An exemplary embodiment of a radio device is disclosed including: a processor-based host application unit configured to provide a user interface for radio operation; a radio module unit configured to communicate data over the air in a specified radio frequency communications protocol, the radio module further configured to, upon a valid request by the host application unit, generate a response to the host application unit, the response including a data packet arranged in the specified communication protocol; and a unified radio programming interface residing between the host application unit and the radio module unit, the radio programming interface implemented in a computer program embodied on a computer readable medium. The radio module includes code segments that: receive a request from the host application unit; validate the request; and submit the request to the radio module if determined to be valid.

Optionally, the radio programming interface further has code segments that assemble a validated request into the specified protocol for receipt by the radio module. The radio programming interface may be partly embedded in the host application unit and partly embedded in the radio module unit. The processor-based host application may be configured to generate a request form for submission to the radio programming interface, and the radio programming interface may be configured to validate the request form. The radio programming interface may further be configured to send one of a validation success or failure notification to the host application unit. The radio programming interface may be configured to parse a validated request form into a valid radio request protocol packet and forward the valid protocol packet to the radio module. The radio module unit may also be configured to validate a content of a valid radio request when received from the radio programming interface unit before fulfilling the request. The radio module unit may be configured to send one of a validation success or failure notification to the radio programming interface.

Also optionally, the radio module unit is configured to generate a response to the host application unit, and the radio programming interface is configured receive the response and assemble a valid radio protocol packet for communication to the host application unit.

As other options, the radio module unit may also a processor-based unit. The request may be one of a configuration request and a data send request. The configuration request may be one of a local radio module configuration request and a remote radio module configuration request. The radio programming interface may includes code segments that download a radio module image.

An exemplary method of operating a radio device is also disclosed. The radio device includes a processor-based host application unit configured to provide a user interface for radio operation and radio module unit configured to communicate data over the air in a specified radio frequency communications protocol. The radio module is configured to generate a response to the host application unit upon a valid request by the host application unit, and the response including a data packet arranged in the specified communication protocol. The method includes: providing a unified radio programming interface residing between the host application unit and the radio module unit, the radio programming interface implemented in a computer program embodied on a computer readable medium with the radio programming interface: receiving a request from the host application unit; validating the request; and submitting the request to the radio module, if the request is determined to be valid.

Optionally, the method may include assembling, with the radio programming interface, a validated request into the specified protocol for receipt by the radio module. Providing the radio programming interface may include partly embedding the radio programming interface in the host application unit and partly embedding the radio programming interface in the radio module unit. The method of may further include: generating, with the processor-based host application, a request form; submitting the request form to the radio programming interface; and validating, with the radio programming interface, the request form. The method may include sending, with the radio programming interface, one of a validation success or failure notification to the host application unit. The method may include parsing, with the radio programming interface, a validated request form into a valid radio request protocol packet and forward the valid protocol packet to the radio module. The method may further include validating, with the radio module unit, a content of the valid radio request before fulfilling the request when the request is received from the radio programming interface unit. The method may further comprise sending, with the radio module unit, one of a validation success or failure notification to the radio programming interface.

Also optionally, the method may further include generating, with the radio module unit, a response to the host application unit; and assembling, with the radio programming interface, a valid radio protocol packet for communication to the host application unit. The radio module unit may also be a processor-based unit. The request may be one of a configuration request and a data send request. The configuration request may be one of a local radio module configuration request and a remote radio module configuration request. The method may also include downloading, with the radio programming interface, a radio module image.

An exemplary embodiment of a computer program product is also disclosed having a readable memory device including computer program logic instructions encoded thereon. When performed on a processor in a radio device including a host application unit and a radio module unit the computer logic instructions provide a method for performing the operations of: receiving a request from the host application unit; validating the request; and submitting the request to the radio module, if the request is determined to be valid.

Optionally, the computer logic instructions may further provide an operation of assembling a validated request into the specified protocol for receipt by the radio module. The computer logic instructions may further provide an operation of sending, with the radio programming interface, one of a validation success or failure notification to the host application unit. Receiving a request form from the host application module may include receiving a request form. The computer logic instructions may further provide an operation of parsing a validated request form into a valid radio request protocol packet and forwarding the valid protocol packet to the radio module.

The computer logic instructions may also optionally provide an operation of receiving a response from the radio module unit; and assembling a valid radio protocol packet corresponding to the response from the radio module unit for communication to the host application unit. The computer logic instructions may further provide an operation of configuring one of a local radio module configuration request and a remote radio module configuration request. The computer logic instructions may further provide an operation of downloading a radio module image.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A radio device comprising:
a processor-based host application unit configured to provide a user interface for radio operation;
a radio module unit configured to communicate data over the air in a specified radio frequency communications protocol, the radio module further configured to, upon a valid request by the host application unit, generate a response to the host application unit, the response including a data packet arranged in the specified communication protocol; and
a unified radio programming interface residing between the host application unit and the radio module unit, the radio programming interface implemented in a computer program embodied on a computer readable medium and having code segments that:
receive a request from the host application unit;
validate the request; and
submit the request to the radio module if determined to be valid.

2. The radio device of claim 1, wherein the radio programming interface further has code segments that assemble a validated request into the specified protocol for receipt by the radio module.

3. The radio device of claim 1, wherein the radio programming interface is partly embedded in the host application unit and partly embedded in the radio module unit.

4. The radio device of claim 1, wherein the processor-based host application is configured to generate a request form for submission to the radio programming interface, and the radio programming interface is configured to validate the request form.

5. The radio device of claim 4, wherein the radio programming interface is further configured to send one of a validation success or failure notification to the host application unit.

6. The radio device of claim 4, wherein the radio programming interface is configured to parse a validated request form into a valid radio request protocol packet and forward the valid protocol packet to the radio module.

7. The radio device of claim 5, wherein the radio module unit is configured to validate a content of a valid radio request when received from the radio programming interface unit before fulfilling the request.

8. The radio device of claim 5, wherein the radio module unit is configured to send one of a validation success or failure notification to the radio programming interface.

9. The radio device of claim 1, wherein the radio module unit is configured to generate a response to the host application unit, and the radio programming interface is configured receive the response and assemble a valid radio protocol packet for communication to the host application unit.

10. The radio device of claim 1, wherein the radio module unit is also a processor-based unit.

11. The radio device of claim 1, wherein the request is one of a configuration request and a data send request.

12. The radio device of claim 11, wherein the configuration request is one of a local radio module configuration request and a remote radio module configuration request.

13. The radio device of claim 1, wherein the radio programming interface includes code segments that download a radio module image.

14. A method of operating a radio device, the radio device including a processor-based host application unit configured to provide a user interface for radio operation and a radio module unit configured to communicate data over the air in a specified radio frequency communications protocol, the radio module configured to generate a response to the host application unit upon a valid request by the host application unit, the response including a data packet arranged in the specified communication protocol, the method comprising:
providing a unified radio programming interface residing between the host application unit and the radio module unit, the radio programming interface implemented in a computer program embodied on a computer readable medium; and
the radio programming interface:
receiving a request from the host application unit;
validating the request; and
submitting the request to the radio module, if the request is determined to be valid.

15. The method of claim 14, further comprising assembling, with the radio programming interface, a validated request into the specified protocol for receipt by the radio module.

16. The method of claim 14, wherein providing the radio programming interface comprises partly embedding the radio programming interface in the host application unit and partly embedding the radio programming interface in the radio module unit.

17. The method of claim 14, further comprising:
generating, with the processor-based host application, a request form;
submitting the request form to the radio programming interface; and
validating, with the radio programming interface, the request form.

18. The method of claim 17, further comprising sending, with the radio programming interface, one of a validation success or failure notification to the host application unit.

19. The method of claim 17, further comprising parsing, with the radio programming interface, a validated request form into a valid radio request protocol packet and forward the valid protocol packet to the radio module.

20. The method of claim 19, further comprising validating, with the radio module unit, a content of the valid radio request before fulfilling the request when the request is received from the radio programming interface unit.

21. The method of claim 17, further comprising sending, with the radio module unit, one of a validation success or failure notification to the radio programming interface.

22. The method of claim 14, further comprising generating, with the radio module unit, a response to the host application unit; and
assembling, with the radio programming interface, a valid radio protocol packet for communication to the host application unit.

23. The method of claim 14, wherein the radio module unit is also a processor-based unit.

24. The method of claim 14, wherein the request is one of a configuration request and a data send request.

25. The method of claim 24, wherein the configuration request is one of a local radio module configuration request and a remote radio module configuration request.

26. The method of claim 14, further comprising downloading, with the radio programming interface, a radio module image.

27. A computer program product having a readable memory device including computer program logic instructions encoded thereon that, when performed on a processor in a radio device including a host application unit and a radio module unit provides a method for performing the operations of:
receiving a request from the host application unit;
validating the request; and
submitting the request to the radio module, if the request is determined to be valid.

28. The computer program product of claim 27, further providing an operation of assembling a validated request into the specified protocol for receipt by the radio module.

29. The computer program product of claim 28, further providing an operation of sending, with the radio programming interface, one of a validation success or failure notification to the host application unit.

30. The computer program product of claim 27, wherein receiving a request form from the host application module comprises receiving a request form.

31. The computer program product of claim 27, further providing an operation of parsing a validated request form into a valid radio request protocol packet and forwarding the valid protocol packet to the radio module.

32. The computer program product of claim 27, further providing an operation of receiving a response from the radio module unit; and
assembling a valid radio protocol packet corresponding to the response from the radio module unit for communication to the host application unit.

33. The computer program product of claim 27, further providing an operation of configuring one of a local radio module configuration request and a remote radio module configuration request.

34. The computer program product of claim 27, further providing an operation of downloading a radio module image.
